(19) United States
(12) Patent Application Publication
(10) Pub. No.: US 2006/0020484 A1
(43) Pub. Date: Jan. 26, 2006

(54) System for informing entrants of the result of an event by electronic message

(76) Inventor: Henry Curwen Hugo, Cape Town (ZA)

Correspondence Address: MR HENRY C. HUGO, 49 COLUMBUS ROAD, CLAREMONT, CAPE TOWN, 7708, ZA

(21) Appl. No.: 10/972,903

(22) Filed: Oct. 26, 2004

(30) Foreign Application Priority Data
Jul. 20, 2004 (ZA) 2004/5755

(51) Int. Cl. G06Q 99/00; G06Q 20/00

(52) U.S. Cl. 705/1; 705/16

(57) ABSTRACT

The invention relates to the inclusion on the Optically Mark Read (OMR) entry form for an event (contest, competition, game of chance, lottery, wager) of a panel to allow the entrant to record their telephone number so that the entrant may be informed of the outcome of the event by electronic message, in the form of SMS (Short Message Service) or faxed text messages, or electronically generated voice mail messages. The present invention includes the OMR entry form, data collection method and electronic processing methods for generating the electronic messages.

### FIELD OF THE INVENTION

This invention relates to a system for running an event such as a competition, game of chance, lottery or wager. In particular this invention relates to the OMR entry form, data collection method and electronic processing methods for generating the electronic messages.

### BACKGROUND & RELATED APPLICATIONS

Currently numerous gambling events (contests, competitions, games of chance, lotteries and wagering contests) such as racing, lotteries and sporting pool competitions use entry forms which are in optically mark readable (OMR) format. Usually such an entry form is a printed card divided into rows and columns. These rows and columns having blocks printed in which the entrant makes a mark to indicate the choices made. The entry form is also divided into panels of related information. This entry form is then read by an OMR machine and the choices made by the entrant are recorded electronically. This information is transmitted to an administrative computer for processing. A printed ticket showing the choices made by the entrant is issued to the entrant as proof of the entry and any wager.

No personal information about the entrant is entered on the entry form or printed on the ticket, only choices relating to the outcome of the event.

Generally the only way the entrant can determine whether he has any claim in the outcome of the event is to read published results of the event and then contact the organisers of the event.

Generally there is no way the event organisers can contact the entrant as no contact information is recorded, only a printed ticket showing event choices made is issued (202).

The only proof an entrant has of a claim is the printed ticket, which if lost can be used by others to claim any winnings. If the printed ticket is destroyed there may be no proof of claim possible.

Both the organisers and the entrant can be the victims of fraud or theft as there is no way of checking the ownership of a event entry ticket.

Organisers cannot make further contact with the entrant for marketing, sales or promotional purposes other than through normal advertising channels in the media. No direct marketing is possible.

Typically there are unclaimed winnings which cannot be traced back to entrants.

### SUMMARY OF THE INVENTION

In a system for running an event such as a contest, competition, game of chance, lottery or wager said system comprising an entry form for recording entry choices in OMR format, an optical mark reading (OMR) machine for reading the information recorded on the entry form, a point of sale machine for printing a ticket showing the entry choices, means for electronically transfering entry information read and stored within the OMR machine to an administrative computer for storage and processing, there is provided according to the invention the step of including in the entry form a panel for recording the entrant's telephone number. Further according to the invention, when the outcome of the event is known, the outcome information and the rules of the event are applied by the administrative computer to the entry information stored and the outcome per entry is determined and recorded. Further the outcome information per entry together with the telephone number on the entry is used by the administrative computer to generate appropriate messages for the entrants. Further the messages generated are transmitted to the entrants by the administrative computer using their telephone numbers in a suitable electronic format via their telephone service providers, for example as SMS (Short Message Service) text messages or fax text messages or electronically generated voice mail messages. Further the messages generated may include marketing, sponsorship or sales information. Further a ticket showing the entry choices , the telephone number and other relevant information such as a ticket number is printed by a point of sale machine and issued to the entrant. Further the choice to enter a telephone number may require the entrant to pay an additional fee for the service provided and the fee is:

relayed to a point of sale machine and collected by an operator together with any entry fee or wager

or charged to the entrant as a reverse charge SMS or call to the telephone number entered on the entry form.

Further the invention is directed at an entry form which includes a panel for recording the entrant's telephone number.

Further there is provided an entry form for an event such as a contest, competition, game of chance, lottery or wager the said form:

being in optical mark readable (OMR) format

being divided into rows and columns containing blocks in which the entrant indicates choices by making marks therein.

being divided into panels for entry of related information regarding the event choices (for example in the case of a lottery entry form a panel of forty nine numbers out of which the entrant would choose and mark six numbers)

having a panel provided for an entrant to enter his/her telephone number by marking the relevant numbered blocks in the panel;

being machine readable by an optical mark reading (OMR) machine.

### BRIEF DESCRIPTION OF FIGURES

FIG. 1 of 5 Example of event entry form in optical mark readable (OMR) format with provision for entry of telephone number

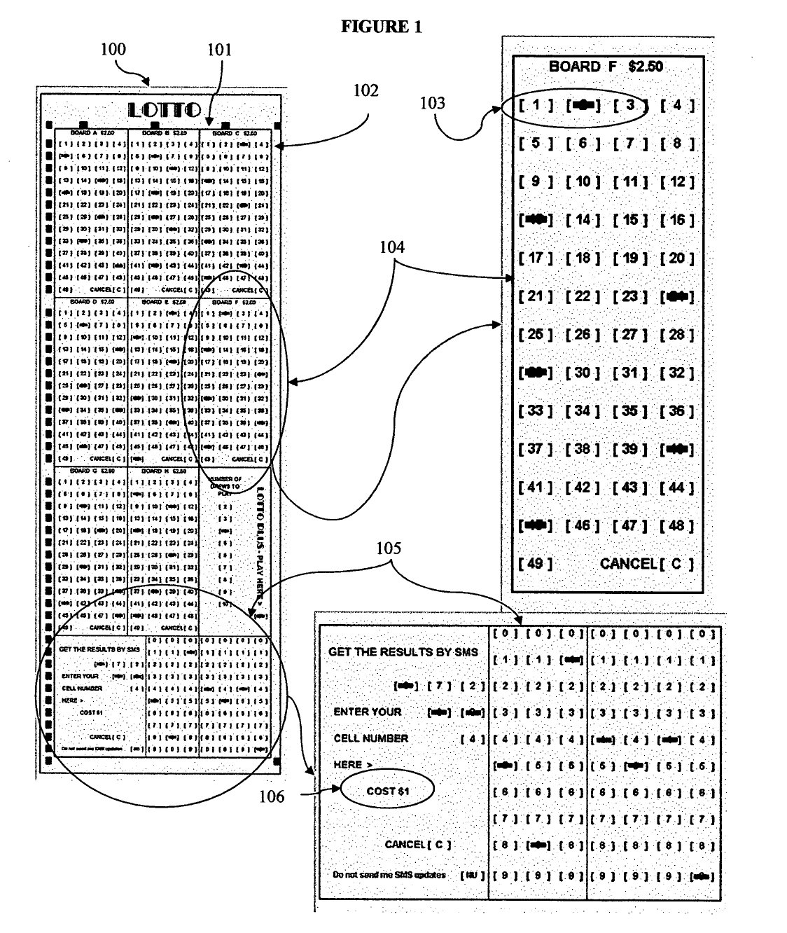

FIG. 2 of 5 Example of printed tickets showing the choices made by the entrant on the OMR entry form and the telephone number.

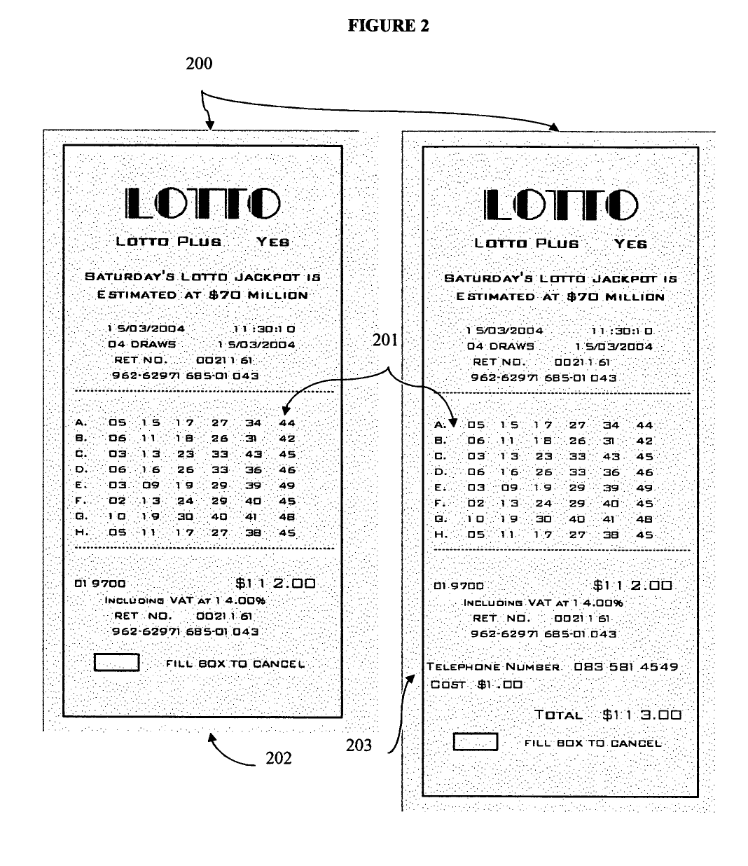

FIG. 3 of 5 Examples of possible messages transmitted to event entrants.

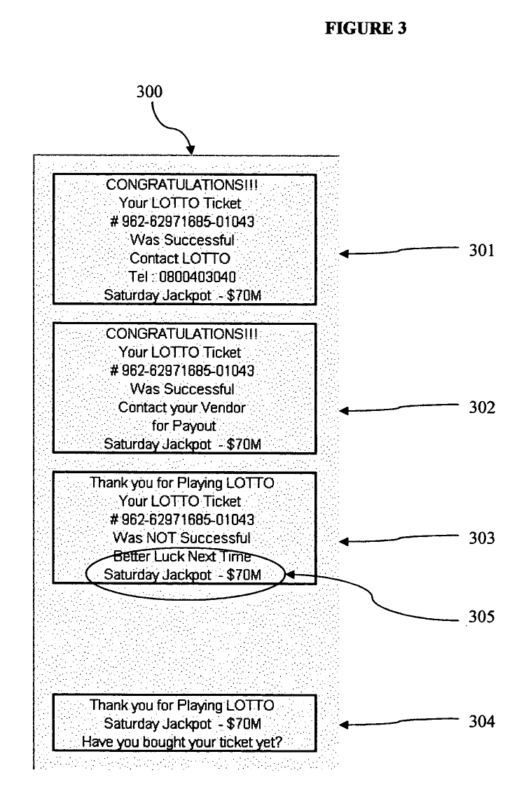

FIG. 4 of 5 Flow chart of system operation.

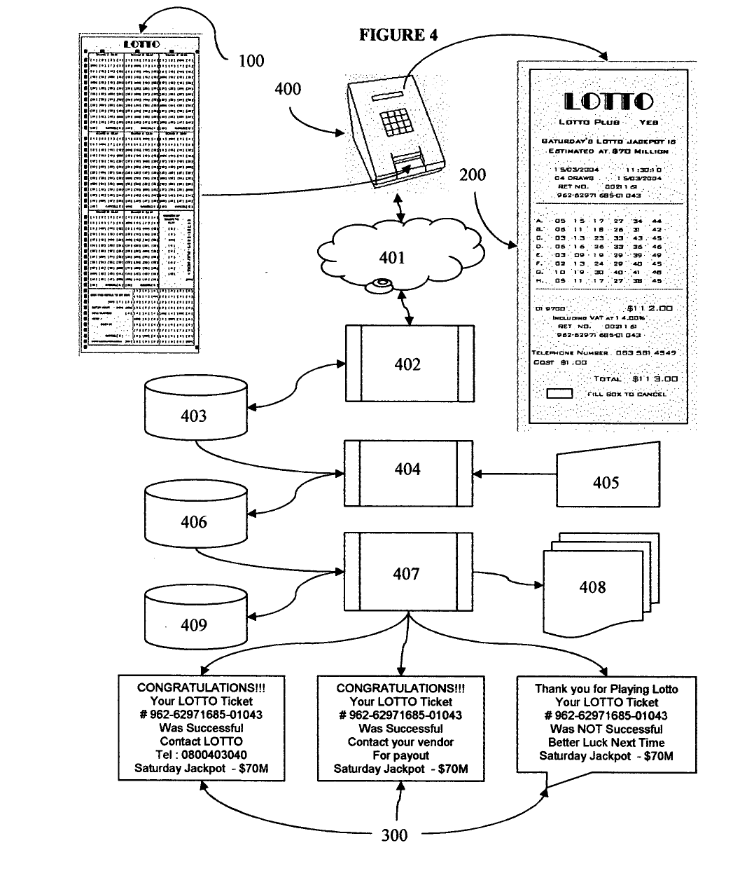

FIG. 5 of 5 Flow chart of marketing using database of telephone numbers.

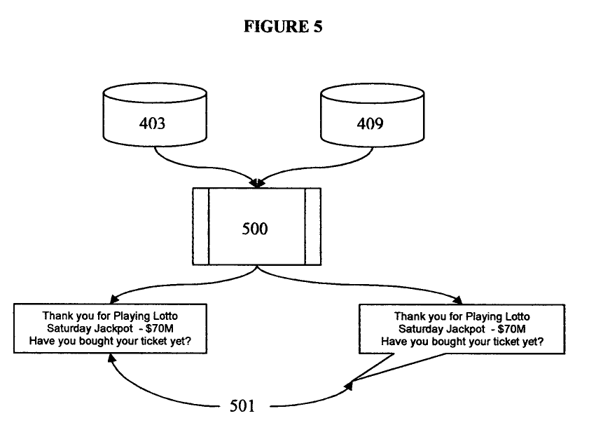

### DETAILED DESCRIPTION OF THE INVENTION

The current invention provides a method for entrants in an event (contest, competition, game of chance, lottery, wager) to record their telephone number (105) together with their event related choices (104, 201) on an entry form (100) for purposes of being informed by the organisers of the event of the outcome of the event by automatically generated and transmitted electronic message.

The current invention describes a system for the organisers of the event (contest, competition, game of chance, lottery, wager) to read, record and process the entry form (100) completed by the event entrant and later inform the entrant of the outcome of the event by automatically generated and transmitted electronic message (300).

The entry form (100) for the event would be a printed form in optical mark readable (OMR) format, being divided into rows (101) and columns (102) and the rows and columns containing blocks (103) in which the entrant indicates choices by making marks in the relevant blocks (103).

The entry form would be divided into panels (104) for entry of related information regarding the event choices, for example in the case of a lottery entry form a panel of forty nine numbers out of which the entrant would choose and mark six numbers.

The entry form would have a panel (105) provided for the entrant to enter their telephone number by marking the relevant numbered blocks in the panel. To reduce the number of entry marks required the codes of the available telephone service providers might be shown as a single block.

The entry form would be readable by an optical mark reading (OMR) machine (400). Typically the form and the ink used are reflective and the marks made are then non-reflective.

The entry form (100) would be read by an optical mark reading (OMR) machine (400) and the information recorded by the entrant on the entry form would be read and stored within the OMR machine. The information read by the OMR machine would include the contest related choices (104) and the telephone number of the entrant (105).

A ticket (200) showing the entry choices (201), the telephone number (203) and other relevant information such as a ticket number would be printed by a point of sale machine and issued to the entrant.

The choice to enter a telephone number might require the entrant to pay an additional fee (106) for the service provided. The fee would typically be printed on the event ticket and be relayed to a point of sale machine and collected by the operator at the point of sale together with any entry fee or wager (203). The fee could also be collected as a reverse charge SMS or call to the telephone number provided on the entry form at a rate higher than a normal SMS or call.

The entry information read and stored within the OMR machine would be electronically transferred (401) to an administrative computer (402) for storage (403) and processing. This would typically be done over a country wide network to a central computer system.

When the outcome of the event is known the outcome information (405) and the rules of the event would then be applied by the administrative computer (404) to the entry information stored (403) and the outcome per entry would be determined and recorded (406). For example in the case of a lottery the numbers drawn would be entered into the administrative computer. The computer would then scan all tickets and entry lines to determine how many numbers the entrant had correctly selected. The number of correct selections would determine how much the entrant was entitled to as a dividend or prize.

The outcome information per entry (406) together with the telephone number on the entry (105,203) would be used by the administrative computer to generate (407) appropriate messages (300) for the entrants. Typically the computer would generate “Bad Luck” or “Good Luck” type messages. If the entrant was successful, the entrant would be advised to contact the ticket vendor or the event organiser to collect their dividend. Unlucky entrants would be encouraged to enter again.

The messages generated could include marketing, sponsorship or sales information as required by the event organisers (305). Such messages could be promotional messages for the next event, or advertising messages for sponsors of the event or simply advertising messages for paying advertisers, all of which would be low cost advertising on the back of the message to the entrant.

The messages generated would be transmitted to the entrants by the administrative computer using their telephone numbers in a suitable electronic format (300), via their telephone service providers

For example as:
SMS (Short Message Service) text messages or
fax text messages or
electronically generated voice mail messages.

Typically the administrative computer would be linked via an ISDN line to the telephone service providers and would transmit the messages using the SMPP (Short Message Peer-to-Peer) protocol. The administrative computer would simultaneously generate transmission reports (408) for administrative purposes.

The event organisers would be able to use the stored entry information (409) including telephone numbers (105,203) at the point of presentation to verify the validity of event printed tickets (200) and the identity of the entrant presenting the ticket when any winnings were being redeemed For example the person at the payout point could ask the entrant presenting the ticket to present a telephone account record for the telephone number on the ticket or present the mobile telephone perhaps and demonstrate that it is legally in their possesion.

The event organisers would be able to use the stored telephone numbers (105,203, 403, 409), current sales data (403) and past sales data (409) for future direct marketing (500, 501). For example by checking (500) the current sales records containing telephone numbers (403) against the past sales records telephone numbers (409) it would be possible to determine which previous entrants had not currently entered and to send them messages encouraging them to enter the current event (501)

1. In a system for running an event such as a contest, competition, game of chance, lottery or wager said system comprising an entry form for recording entry choices in OMR format, an optical mark reading (OMR) machine for reading the information recorded on the entry form, a point of sale machine for printing a ticket showing the entry choices, means for electronically transfering entry information read and stored within the OMR machine to an administrative computer for storage and processing, the step of including in the entry form a panel for recording the entrant's telephone phone number.

2. A system as claimed in claim 1 in which, when the outcome of the event is known, the outcome information and the rules of the event are applied by the administrative computer to the entry information stored and the outcome per entry is determined and recorded.

3. A system as claimed in any of the preceding claims in which the outcome information per entry together with the telephone number on the entry is used by the administrative computer to generate appropriate messages for the entrants.

4. A system as claimed in claim 3 in which the messages generated are transmitted to the entrants by the administrative computer using their telephone numbers in a suitable electronic format via their telephone service providers, for example as: SMS (Short Message Service) text messages or fax text messages or electronically generated voice mail messages

5. A system as claimed in claim 4 in which the messages generated include marketing, sponsorship or sales information.

6. A system as claimed in any of the preceding claims in which a ticket showing the entry choices, the telephone number and other relevant information such as a ticket number is printed by a point of sale machine and issued to the entrant.

7. A system as claimed in any of the preceding claims in which the choice to enter a telephone number requires the entrant to pay an additional fee for the service provided and the fee is:
relayed to a point of sale machine and collected by an operator together with any entry fee or wager,
or charged to the entrant as a reverse charge SMS or call to the telephone number entered on the entry form.

8. An entry form for use in a system as claimed in any of the preceding claims which form includes a panel for recording the entrant's telephone phone number.

9. An entry form for an event such as a contest, competition, game of chance, lottery or wager the said form:
a. being in optical mark readable (OMR) format
b. being divided into rows and columns containing blocks in which the entrant indicates choices by making marks therein.
c. being divided into panels for entry of related information regarding the event choices (for example in the case of a lottery entry form a panel of forty nine numbers out of which the entrant would choose and mark six numbers)
d. having a panel provided for an entrant to enter his/her telephone number by marking the relevant numbered blocks in the panel;
e. being machine readable by an optical mark reading (OMR) machine.
